(19) United States
(12) Patent Application Publication
(10) Pub. No.: US 2005/0088526 A1
(43) Pub. Date: Apr. 28, 2005

(54) Remote audio controlling system and method

(75) Inventors: Chi-Chih Wang, Tu-Cheng (TW); Bing-Yu He, Shenzhen (CN); Zhi-Meng Cao, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/927,839

(22) Filed: Aug. 26, 2004

(30) Foreign Application Priority Data
Oct. 22, 2003 (TW) 92129257

(51) Int. Cl. H04N 5/76; H04N 5/225; G11B 7/085; G11B 21/08

(52) U.S. Cl. 348/207.1; 386/117

(57) ABSTRACT

A remote audio controlling system for providing remote audio controlling services over a network environment includes a web server (2), a database (1), a number of monitor computers (5), a number of cameras (60), and a number of audio information output apparatuses (62). The monitor computers, cameras and audio information output apparatuses link to the web server through a network (4). The web server includes a video data obtaining module (22) for obtaining video data from the cameras; an audio data receiving module (23) for receiving audio data from the monitor computers; and an audio data transmitting module (24) for transmitting the received audio data to the audio information output apparatuses. A related remote audio controlling method is also disclosed.

### BACKGROUND OF THE INVENTION

1. Field of the Invention

The present invention relates generally to systems and methods for automated process monitoring, and more particularly to a remote audio controlling system and method which can provide remote audio controlling services in order to remedy defective products at a production line.

2. Background of the Invention

A shop floor control system is an industry standard term describing a computer-based system that provides access to all manufacturing activities that generally take place at manufacturing sites. The manufacturing activities typically include master production scheduling, process monitoring, quality control, and so on. Monitoring manufacturing processes is important for a manufacturing enterprise's success because of the high cost of various manufacturing errors. Manufacturing errors can result in wastage of raw materials, machine down time, and reworking or scrapping of defective products. The cost of a manufacturing error is minimized when the error is detected and corrected at the earliest possible time in the manufacturing process. Problems can be detected and resolved at the earliest possible time and at the lowest possible cost through real-time process monitoring.

A conventional process monitoring system comprises various detection equipment and sensors, with a central monitoring device collecting various data on the process at predetermined intervals of time. When an abnormality is detected in the process, the central monitoring device notifies supervising personnel via a computer terminal display such as a CRT (Cathode-Ray Tube). Information concerning the occurrence of the abnormality is displayed on the CRT, thereby enabling the supervising personnel to remedy the abnormality. However, this conventional method cannot transmit audio information which may be necessary or useful in remedying the abnormality appropriately and quickly according to the obtained information on abnormality. Further, the process monitoring system generally uses special monitoring equipment, which is expensive.

Another kind of process monitoring method is disclosed in U.S. Pat. No. 6,510,352 issued on Jan. 21, 2003 and entitled Methods And Apparatus For Object-based Process Control. The patent provides a plurality of control devices that provide virtual machine environments in which Java objects, or other such software constructs, are executed to implement process control. These objects define blocks, which are the basic functional units of the control. They also define input, output and body parts from which blocks are formed, and the signals that are communicated between blocks. The objects also define nested and composite groupings of blocks used to control loops and higher-level control functions. However, the signals that are communicated between blocks are limited to word information displayed on screens installed in manufacturing sites. Furthermore, the patent does not address the issue of providing a system and/or method for monitoring and controlling a manufacturing process in a direct and easy way, such as by using video or audio devices. This can often lead to difficulties in timely handling abnormalities that occur in the manufacturing process.

To overcome the foregoing problems, what is needed is a system and method for providing remote audio controlling services according to obtained video data.

### SUMMARY OF THE INVENTION

It is an objective of the present invention to provide a system and method for providing remote audio controlling services according to obtained video data in order to facilitate remedying of defective products.

To accomplish the above objective, a remote audio controlling system in accordance with a preferred embodiment of the present invention comprises a web server, a database and a plurality of monitor computers, a plurality of cameras, a plurality of audio information output apparatuses. The monitor computers, cameras and audio information output apparatuses are link to the web server through a communication means. The web server comprises: a video data obtaining module for obtaining video data from said cameras; an audio data receiving module for receiving audio data from said monitor computers; and an audio data transmitting module for transmitting the received audio data to said audio information output apparatus.

Further, a preferred remote audio controlling method according to the present invention is also provided. The method comprises the following steps: obtaining video data from a camera; determining whether it is necessary to transmit audio data from any monitor computer to any audio information output apparatus according to the obtained video data; receiving the audio data from the monitor computer if it is necessary to transmit the audio data; and transmitting the received audio data to the audio information output apparatus installed at a corresponding manufacturing site for remedying of defective products.

Other objects, novel features and advantages of the present invention will be drawn from the following detailed description of the present invention with the attached drawings, in which:

### BRIEF DESCRIPTION OF THE DRAWINGS

FIG. 1 is a schematic diagram of hardware configuration of the remote audio controlling system in accordance with the preferred embodiment of the present invention;

FIG. 2 is a schematic diagram of main software function modules of a web server of the system of FIG. 1; and

FIG. 3 is a flowchart of a remote audio controlling method according to the present invention.

### DETAILED DESCRIPTION OF THE INVENTION

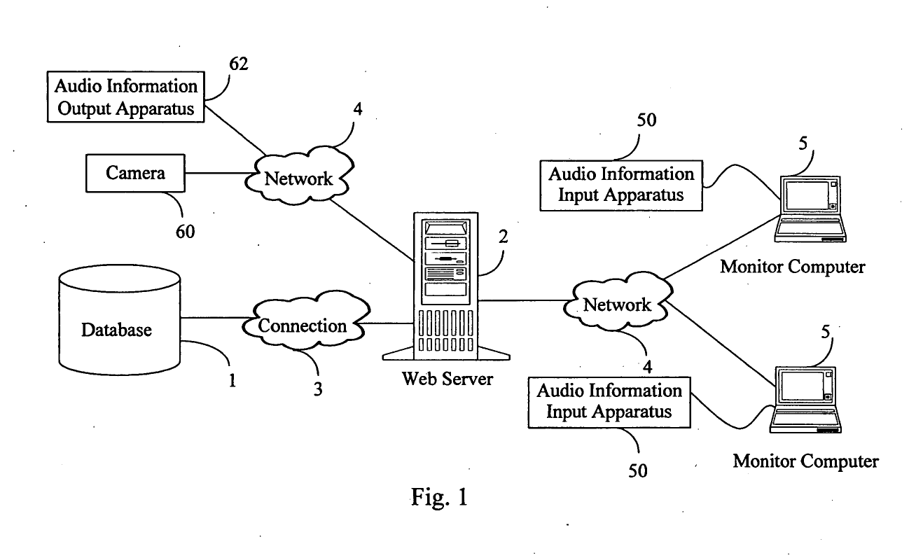

FIG. 1 is a schematic diagram of hardware configuration of a remote audio controlling system in accordance with the preferred embodiment of the present invention. The remote audio controlling system comprises a database 1, a web server 2, a plurality of monitor computers 5 (only two shown), a plurality of cameras 60 (only one shown), and a plurality of audio information output apparatuses 62 (only one shown). The database 1 is connected with the web server 2 via a connection 3. The connection 3 is a kind of database connectivity such as an ODBC (Open Database Connectivity) or a JDBC (Java Database Connectivity). The database 1 is used for storing information on authorized users and audio data. Information on each authorized user comprises a user ID and a corresponding password. The audio data are digital signals converted from corresponding analog audio signals, and can be identified and processed by computers.

The monitor computers 5 are connected with the web server 2 through a network 4. The network 4 may be an intranet, the Internet, or any other suitable communications network. Each monitor computer 5 is connected with a plurality of audio information input apparatuses 50 (only one shown for each monitor computer 5), which are used to input audio information. The audio information comprises analog audio signals input by supervising personnel through the audio information input apparatuses 50. Each audio information input apparatus 50 corresponds to a manufacturing site. Each monitor computer 5 runs a communication procedure in order to obtain video data from the web server 2 for monitoring of operations of manufacturing sites, to convert video data into human-view video information and display the video information on a computer terminal display such as a CRT (Cathode-Ray Tube), to receive audio information input by an audio information input apparatus 50, and to convert the audio information into audio data and transmit the audio data to the web server 2. The video data are compiled digital signals that can be identified and processed by computers. The video information comprises analog video signals captured by the cameras 60. The cameras 60 and the audio information output apparatuses 62 are installed at various manufacturing sites. The cameras 60 are used for capturing video information from the manufacturing sites, converting the captured video information into video data, and transmitting the video data to the web server 2. The audio information output apparatuses 62 are used for receiving audio data transmitted from the web server 2, converting the received audio data into audio information, and outputting the audio information to manufacturing operators.

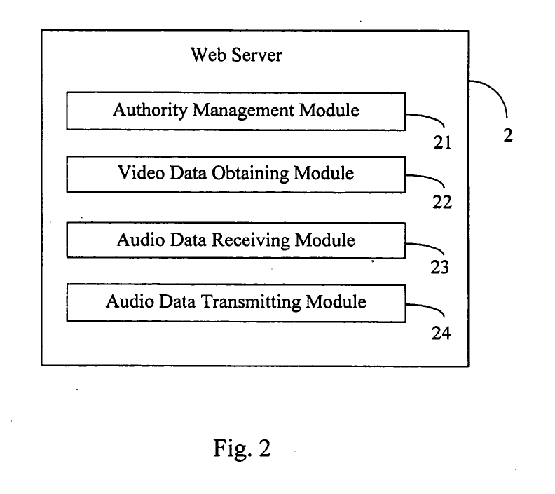

FIG. 2 is a schematic diagram of software function modules of the web server 2. The web server 2 is provided to obtain video data from the various cameras 60, to receive audio data from the monitor computers 5, and to transmit the audio data to corresponding audio information output apparatuses 62. The web server 2 comprises an authority management module 21, a video data obtaining module 22, an audio data receiving module 23, and an audio data transmitting module 24.

The authority management module 21 is provided to receive user IDs and passwords from the monitor computers 5, to determine whether each user is an authorized user, and to reject access by the user if the user is not an authorized user. The video data obtaining module 22 is provided to obtain video data from various cameras 60 installed at various manufacturing sites, and to transmit the video data to the monitor computers 5. The audio data receiving module 23 is provided to receive audio data transmitted from the monitor computers 5. The audio data transmitting module 24 is provided to determine whether it is necessary to transmit audio data to the manufacturing sites, and to transmit the received audio data to the audio information output apparatuses 62 installed at various manufacturing sites if necessary.

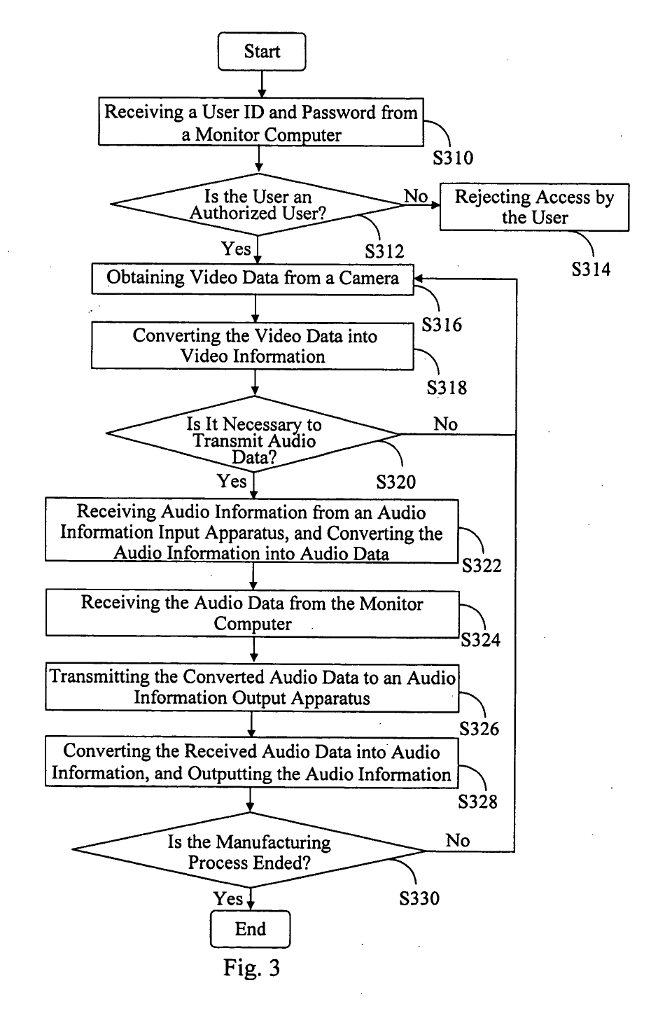

FIG. 3 is a flowchart of a remote audio controlling method in accordance with the present invention. In step S310, the authority management module 21 receives a user ID and password from a monitor computer 5. In step S312, the authority management module 21 determines whether the user is an authorized user according to information on authorized users stored in the database 1. If the user is not an authorized user, in step S314, the authority management module 21 rejects access by the user. If the user is an authorized user, in step S316, the video data obtaining module 22 obtains video data from a camera 60 installed at a manufacturing site. In step S318, a monitor computer 5 receives the video data from the web server 2 by running a communication procedure, converts the received video data into video information, and displays the video information on a screen of the monitor computer 5. In step S320, the audio data transmitting module 24 determines whether it is necessary to transmit audio data to any audio information output apparatus 62 installed at a corresponding manufacturing site according to the obtained video data. If it is not necessary to transmit audio data to the manufacturing site, the procedure return to step S316 described above.

If it is necessary to transmit audio data to the manufacturing site, in step S322, the monitor computer 5 receives audio information from a corresponding audio information input apparatus 50, and converts the received audio information into audio data. In step S324, the audio data receiving module 23 receives the audio data transmitted from the monitor computer 5. In step S326, the audio data transmitting module 24 transmits the received audio data to the audio information output apparatus 62 installed at the manufacturing site in order to facilitate remedying of defective products. In step S328, the audio information output apparatus 62 converts the received audio data into audio information, and outputs the converted audio information. In step S330, the web server 2 determines whether the manufacturing process is ended. If the manufacturing process is not ended, the procedure returns to step S316 described above. Otherwise, the procedure is ended.

Although the present invention has been specifically described on the basis of a preferred embodiment and preferred method, the invention is not to be construed as being limited thereto. Various changes or modifications may be made to said embodiment and method without departing from the scope and spirit of the invention.

1. A remote audio controlling system for providing remote audio controlling services over a network environment, the system comprising a web server, a database, a plurality of monitor computers, a plurality of cameras, and a plurality of audio information output apparatuses, said monitor computers, cameras and audio information output apparatuses linking to the web server through a communication means, wherein the web server comprises:
a video data obtaining module for obtaining video data from said cameras; an audio data receiving module for receiving audio data from said monitor computers; and
an audio data transmitting module for transmitting the received audio data to said audio information output apparatuses.

2. The remote audio controlling system according to claim 1, wherein the web server further comprises an authority management module for receiving user IDs and passwords from said monitor computers, for determining whether a user is an authorized user, and for rejecting access by the user if the user is not an authorized user.

3. The remote audio controlling system according to claim 1, wherein said cameras are for capturing video information from a plurality of manufacturing sites, and converting the captured video information into video data.

4. The remote audio controlling system according to claim 1, wherein said audio information output apparatuses are for converting the received audio data into audio information, and outputting the audio information.

5. The remote audio controlling system according to claim 1, wherein said monitor computers are used for receiving video data and audio information, converting the received video data into video information, and converting the received audio information into audio data.

6. A remote audio controlling method comprising the steps of:
obtaining video data from a camera;
determining whether it is necessary to transmit audio data from any monitor computer to any audio information output apparatus according to the obtained video data;
receiving the audio data from the monitor computer if it is necessary to transmit the audio data; and
transmitting the received audio data to the audio information output apparatus installed at a corresponding manufacturing site for remedying of defective products.

7. The remote audio controlling method according to claim 6, further comprising the step of receiving a user ID and password, and determining whether the user is an authorized user.

8. The remote audio controlling method according to claim 7, further comprising the step of rejecting access by the user if the user is not an authorized user.

9. The remote audio controlling method according to claim 6, further comprising the step of providing the monitor computer for receiving video data, and converting the received video data into human-view video information.

10. The remote audio controlling method according to claim 6, further comprising the step of converting the received audio data into audio information, and outputting the audio information.

11. A method for controlling a remote audio system in a remote monitoring area, comprising the steps of:
monitoring video data transmitted from said remote monitoring area;
generating informative audio data in a condition of occurrence of an abnormal situation in said remote monitoring area;
transmitting said audio data to said remote audio system in said remote monitoring area to play said audio data.

12. The method according to claim 11, further comprising the step of receiving a human-understandable audio information and converting said audio information into said audio data, and converting said audio data back to said audio information after said transmission.

13. The method according to claim 11, further comprising the step of converting said audio data into an human-viewable video information in a viewable device in said remote monitoring area.
